(19) United States
(12) Patent Application Publication
(10) Pub. No.: US 2024/0165559 A1
(43) Pub. Date: May 23, 2024

(54) SCRUBBER SYSTEM

(71) Applicant: SAMSUNG ELECTRONICS CO., LTD., Suwon-si (KR)

(72) Inventor: Changseok YOO, Suwon-si (KR)

(21) Appl. No.: 18/511,012

(22) Filed: Nov. 16, 2023

(30) Foreign Application Priority Data
Nov. 22, 2022 (KR) 10-2022-0157510

(51) Int. Cl. B01D 53/76; B01D 47/06; B01D 53/68; B01D 53/70; B01D 53/75

(52) U.S. Cl. CPC B01D 53/76; B01D 47/06; B01D 53/68; B01D 53/70; B01D 53/75; B01D 2257/204; B01D 2257/2066; B01D 2258/0216

(57) ABSTRACT

A scrubber system having a lower body, a scrubber located in the lower body, the scrubber having a reactor and a wet treatment performer connected to the reactor, the scrubber being configured in the form of a chiffonier, an upper body located on the lower body, and a pump located in the upper body, wherein the pump pumps a harmful gas from a manufacturing device into the reactor, and the scrubber purifies the harmful gas and discharges a purified gas to the outside of the upper body.

### CROSS-REFERENCE TO RELATED APPLICATION

Korean Patent Application No. 10-2022-0157510, filed on Nov. 22, 2022, in the Korean Intellectual Property Office, is incorporated by reference herein in its entirety.

### BACKGROUND

### 1. Field

A scrubber system is disclosed.

### 2. Description of the Related Art

Manufacturing devices used in electronic devices, such as semiconductor devices or display devices, emit various types of harmful gases during a manufacturing process.

### SUMMARY

Embodiments are directed to a scrubber system, having a lower body, a scrubber located in the lower body, the scrubber including a reactor and a wet treatment performer connected to the reactor, and the scrubber being configured in the form of a chiffonier, an upper body located on the lower body, and a pump located in the upper body for pumping a harmful gas from a manufacturing device into the reactor, the scrubber purifying the harmful gas and discharging a purified gas outside of the upper body.

Embodiments are directed to a scrubber system, having a lower body, a first scrubber and a second scrubber adjacent to each other in the lower body, wherein the first scrubber includes a first reactor and a first wet treatment performer connected to the first reactor, the second scrubber includes a second reactor and a second wet treatment performer connected to the second reactor, and the first scrubber and the second scrubber are configured in the form of a chiffonier, an upper body located on the lower body, and a first pump located in the upper body, the first pump providing a first harmful gas from a first manufacturing device into the first reactor, the first scrubber purifying the first harmful gas and discharging a first purified gas to the outside of the upper body, and the first pump providing a second harmful gas from a second manufacturing device into the second reactor, the second scrubber purifying the second harmful gas and discharging a second purified gas to the outside of the upper body.

Embodiments are directed to a scrubber system, having a lower body, a first scrubber and a second scrubber adjacent to each other in the lower body, wherein the first scrubber includes a first reactor and a first wet treatment performer connected to the first reactor, the second scrubber includes a second reactor and a second wet treatment performer connected to the second reactor, and the first scrubber and the second scrubber are configured in the form of a chiffonier, an upper body located on the lower body, and a first pump located in the upper body, the first pump pumping a first harmful gas from a first manufacturing device into one of the first reactor and the second reactor, and the first scrubber and the second scrubber purify the first harmful gas to discharge a first purified gas to the outside of the upper body.

### BRIEF DESCRIPTION OF THE DRAWINGS

Features will become apparent to those of skill in the art by describing in detail exemplary embodiments with reference to the attached drawings, in which:

FIG. 1 is a schematic diagram of a scrubber system according to an example embodiment.

FIG. 2 is a cross-sectional, schematic view of a scrubber system according to an example embodiment.

FIG. 3 is a perspective, schematic view of a scrubber system according to an example embodiment.

FIG. 4 is a cross-sectional view of a reactor and a wet treatment performer of a scrubber system showing a configuration according to an example embodiment.

FIG. 5 is a partial, cross-sectional view of a detailed configuration of the wet treatment performer shown in FIG. 4.

FIG. 6 is a cross-sectional, schematic view of a scrubber system according to an example embodiment.

FIG. 7 is a perspective, schematic view of a scrubber system according to an example embodiment.

FIG. 8 is a cross-sectional, schematic view of a scrubber system according to an example embodiment.

FIG. 9 is a cross-sectional, schematic view of a scrubber system according to an example embodiment.

FIG. 10 is a cross-sectional, schematic view of a scrubber system according to an example embodiment.

FIG. 11 is a cross-sectional, schematic view of a scrubber system according to an example embodiment.

FIG. 12 is a cross-sectional, schematic view of a scrubber system according to an example embodiment.

FIG. 13 is a cross-sectional, schematic view of a scrubber system according to an example embodiment.

FIG. 14 is a cross-sectional, schematic view of a scrubber system according to an example embodiment.

### DETAILED DESCRIPTION

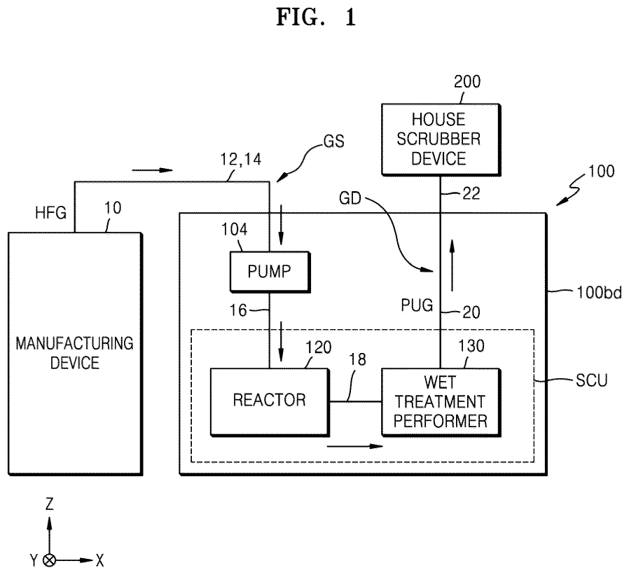

FIG. 1 is a schematic diagram of a scrubber system 100 according to an example embodiment. The scrubber system 100 according to an embodiment may be connected to a manufacturing device 10 and used. The manufacturing device 10 may be an apparatus used in an electronic device, such as a semiconductor device or a display device. The manufacturing device 10 may be a deposition device or an etching device.

Harmful gas HFG may be discharged from the manufacturing device 10. Examples of the harmful gas HFG may include perfluoro-compounds (PFCs), such as NF₃, C₂F₆, or C₃F₈. This harmful gas HFG may be purified through the scrubber system 100 and purified gas PUG may be discharged. As used herein, the term “or” is not an exclusive term, e.g., “A or B” would include A, B, or A and B.

The scrubber system 100 may include a pump 104 and a scrubber SCU. The scrubber system 100 may be an integrated system including the pump 104 and the scrubber SCU. The pump 104 and the scrubber SCU may be installed on a body 100bd.

The scrubber SCU may be of a chiffonier type. In addition, the pump 104 may be located above the scrubber SCU to solve clogging of a gas supply pipe between the pump 104 and the scrubber SCU. In the drawings below including FIG. 1, X and Y directions may be planes parallel to the body 100bd. The X and Y directions may be a floor plane on which the manufacturing device 10 or the body 100bd may be supported. The Z direction may be a vertical direction perpendicular to a floor plane on which the manufacturing device 10 or the body 100bd may be supported.

The scrubber SCU may include a reactor 120 and a wet treatment performer 130. The wet treatment performer 130 may be referred to as a wet processing. The reactor 120 may be connected to the wet treatment performer 130 by a gas connection pipe 18.

Harmful gas HFG discharged from the manufacturing device 10 may be injected into the reactor 120 through the pump 104 and a gas supply pipe GS as indicated by the arrows. The gas supply pipe GS may include a first gas supply pipe 12, a second gas supply pipe 14, and a third gas supply pipe 16.

Harmful gas HFG may be injected into the pump 104 through the first and second gas supply pipes 12 and 14. Harmful gas HFG passing through the pump 104 may be injected into the reactor 120 through the third gas supply pipe 16. The reactor 120 may primarily burn harmful gas HFG to remove ignitable or explosive gas. As indicated by the arrows, the wet treatment performer 130 may perform a secondary treatment process of secondarily dissolving a primarily treated gas passing through the reactor 120 in water-soluble water, to discharge a purified gas PUG to a gas discharge pipe GD.

In other words, the harmful gas HFG discharged from the manufacturing device 10 may be burned, oxidized, or thermally decomposed in the reactor 120, thereby being primarily treated. The primarily treated gas passing through the reactor 120 may include some gas or dust particles that have not yet been treated.

The primarily treated gas passing through the reactor 120 may be transferred to the wet treatment performer 130. The wet treatment performer 130 may spray water to the primarily treated gas to perform a secondary treatment process of wetting to separate untreated dust particles included in the primarily treated gas. By performing primary and secondary treatments on the harmful gas HFG, purified gas PUG may be discharged to the gas discharge pipe GD from the wet treatment performer 130.

The gas discharge pipe GD may include a first gas discharge pipe 20 connected to the wet treatment performer 130 and may also include a second gas discharge pipe 22 connected to a house scrubber device 200. The purified gas PUG discharged to the gas discharge pipe GD may be discharged into the air through the house scrubber device 200.

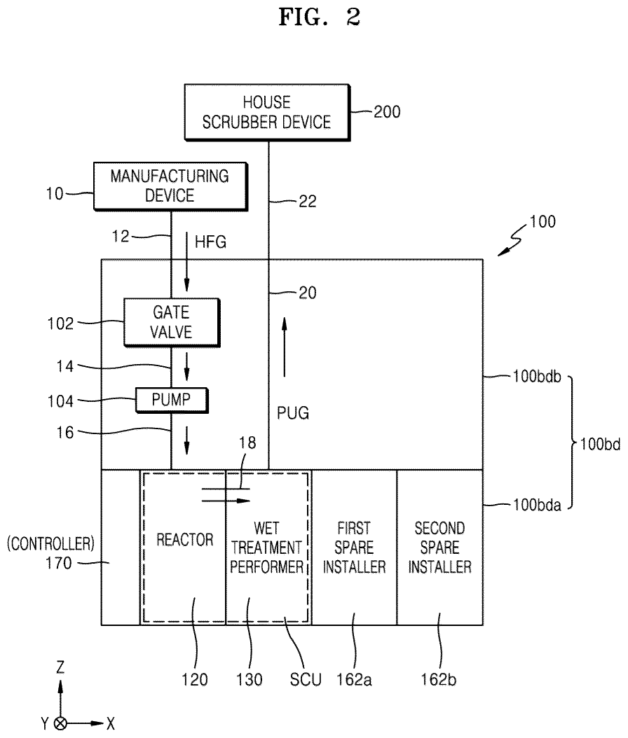

FIG. 2 is a cross-sectional, schematic view of the scrubber system 100 according to an example embodiment. The description provided above with respect to FIG. 1 will not be repeated, unless necessary, with respect to FIG. 2. The scrubber system 100 may include the body 100bd including a lower body 100bda and an upper body 100bdb. The body 100bd may be referred to as a chassis or a frame. The upper body 100bdb may be on the lower body 100bda.

The scrubber system 100 may include a scrubber SCU (indicated with dashed lines) located in the lower body 100bda. The scrubber SCU may include the reactor 120 and the wet treatment performer 130. The reactor 120 may be adjacent to the wet treatment performer 130. The reactor 120 and the wet treatment performer 130 may be connected to each other by a gas connection pipe 18. The scrubber SCU may be of a chiffonier type.

In some embodiments, the scrubber system 100 may further include a plurality of spare installers 162a and 162b for installing additional scrubbers in the lower body 100bda. The spare installers 162a and 162b may include a first spare installer 162a and a second spare installer 162b. An additional reactor may be installed on the first spare installer 162a, and an additional wet treatment performer may be installed on the second spare installer 162b. Accordingly, the scrubber system 100 may increase the gas purifying capacity of treating harmful gas and discharging purified gas.

In the scrubber system 100, a controller 170 may be provided in the lower body 100bda. The controller 170 may be an element that mechanically and electrically controls all components of the scrubber system 100.

The scrubber system 100 may have a pump 104 in the upper body 100bdb. The pump 104 may be located on a scrubber SCU. The scrubber system 100 may achieve space efficiency in a manufacturing plant by arranging the scrubber SCU below the pump 104 The pump 104 may be located above the scrubber SCU in the Z direction. The pump 104 may inject harmful gas HFG from the manufacturing device 10 into the reactor 120.

The scrubber SCU may purify the harmful gas HFG and discharge the purified gas PUG to the outside of the upper body 100bdb. When the pump 104 is installed above the scrubber SCU, the harmful gas HFG may have a good gas flow in the Z direction, and thus, a phenomenon in which foreign matter, e.g., powders or precipitates, occurs in the gas supply pipe, e.g., the third gas supply pipe 16, to block the gas supply pipe may be avoided or prevented.

A process of injecting harmful gas HFG from the manufacturing device 10 into the scrubber system 100 and a process of purifying the harmful gas HFG through the scrubber SCU to discharge the purified gas PUG to the outside will now be described in detail below.

The harmful gas HFG discharged from the manufacturing device 10 may flow into the scrubber system 100 through the first gas supply pipe 12 as indicated by the arrows. A gate valve 102 may be connected to the first gas supply pipe 12. The gate valve 102 may be a valve that turns on or off the flow of the harmful gas HFG introduced from the first gas supply pipe 12 or controls the amount of the harmful gas HFG that is allowed to flow into the scrubber system 100.

The gate valve 102 may be connected to the pump 104 through the second gas supply pipe 14. The second gas supply pipe 14 may connect the gate valve 102 to the pump 104. The harmful gas HFG passing through the pump 104 may be injected into the reactor 120 through the third gas supply pipe 16, i.e., the third gas supply pipe 16 may connect the pump 104 to the reactor 120.

The reactor 120 may primarily burn the harmful gas HFG and transfer the burnt harmful gas HFG to the wet treatment performer 130 through the gas connection pipe 18 as indicated by the arrow. The wet treatment performer 130 may discharge a purified gas PUG through a secondary treatment of secondarily dissolving the primarily treated gas that may have passed through the reactor 120 in water-soluble water.

The purified gas PUG may be discharged to the first gas discharge pipe 20 as indicated by the arrow. The purified gas PUG discharged to the first gas discharge pipe 20 may be discharged into the air through the second gas discharge pipe 22 and the house scrubber device 200. The house scrubber device 200 may be a gas purification device installed in a manufacturing plant.

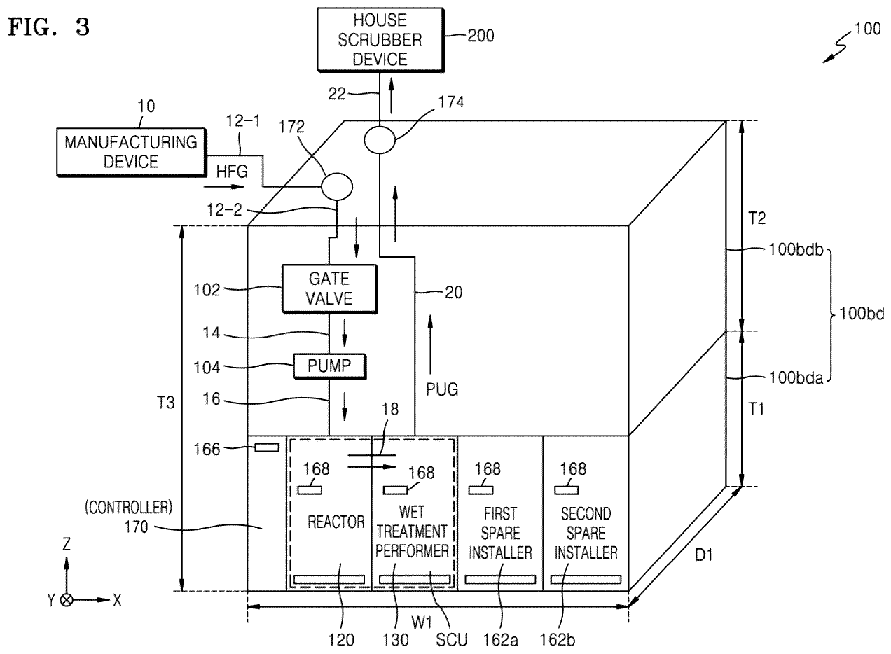

FIG. 3 is a perspective, schematic view of the scrubber system 100 according to an example embodiment. The description provided above with respect to FIGS. 1 and 2 will not be repeated, unless necessary, with respect to FIG. 3. The scrubber system 100 may include the body 100bd including the lower body 100bda and the upper body 100bdb. The body 100bd may have a rectangular parallelepiped shape.

The body 100bd may have a width W1 in an X direction, a depth DI in a Y direction, and a height T3 in a Z direction. The lower body 100bda may have a height T1 in the Z direction. The upper body 100bdb may have a height T2 in the Z direction.

In some embodiments, T1 may be several meters (m), e.g., about 1 to about 2 meters. T2 may be several meters (m), e.g., 1 to 2 meters. T3 may be several meters (m), e.g., about 2 to about 4 meters. W1 may be several meters (m), e.g., about 2 to about 4 meters. W1 may vary depending on the number of spare installers 162a and 162b. In FIG. 3, although two spare installers 162a and 162b, e.g., the first and second spare installers 162a and 162b, may be included, more spare installers may be included as needed.

The scrubber system 100 may include a scrubber SCU (indicated by dashed lines) located in the lower body 100bda. The scrubber SCU may include a reactor 120 and a wet treatment performer 130. The reactor 120 and the wet treatment performer 130 may be located separately from each other in the lower body 100bda. The reactor 120 may be connected to the wet treatment performer 130 by a gas connection pipe 18.

As described above, the scrubber SCU may be configured in the form of a chiffonier. The reactor 120 may be pulled out in a reverse Y direction using a handle 168, and may be pushed back in the Y direction using the handle 168. Like the reactor 120, the wet treatment performer 130 may be pulled out in the reverse Y direction using a handle 168, and may be pushed back in the Y direction using the handle 168.

The scrubber system 100 may include a controller 170 located in the lower body 100bda. The controller 170 may be configured in the form of a chiffonier. The controller 170 may be pulled out in the reverse Y direction using a handle 166, and may be pushed back in the Y direction using the handle 166.

The scrubber system 100 may include first and second spare installers 162a and 162b. The first and second spare installers 162a and 162b may be configured in the form of a chiffonier. The first and second spare installers 162a and 162b may be pulled out in the reverse Y direction using a handle 168 and pushed in the Y direction again using the handle 168.

The scrubber system 100 may have a pump 104 within the upper body 100bdb. The pump 104 may be located in the upper body 100bdb on the scrubber SCU. The pump 104 may be above the scrubber SCU in the Z direction. The pump 104 may inject a harmful gas HFG from the manufacturing device 10 into the reactor 120.

The scrubber SCU may purify the harmful gas HFG and discharge a purified gas PUG to the outside of the upper body 100bdb. As described above, when the pump 104 is installed above the scrubber SCU, the harmful gas HFG may have a good gas flow in the Z direction, so that the gas supply pipe, e.g., the third gas supply pipe 16, may be prevented from being clogged by foreign matter, such as powder, occurring therein.

The upper body 100bdb may include a gas inlet 172 and a gas outlet 174. The harmful gas HFG discharged from the manufacturing device 10 may flow into the scrubber system 100 through a first sub-gas supply pipe 12-1 and the gas inlet 172 as indicated by the arrows. The second sub-gas supply pipe 12-2 may be connected to the gas inlet 172. The first sub-gas supply pipe 12-1 and a second sub-gas supply pipe 12-2 are collectively referred to as the first gas supply pipe 12 for convenience in the above description.

A gate valve 102 may be connected to the second sub-gas supply pipe 12-2. The gate valve 102 may be connected to the pump 104 through a second gas supply pipe 14. The pump 104 may be connected to the third gas supply pipe 16. The harmful gas HFG passing through the pump 104 may be injected into the reactor 120 through the third gas supply pipe 16.

The reactor 120 may primarily burn the harmful gas HFG and transfer the burnt harmful gas to the wet treatment performer 130 through the gas connection pipe 18 as indicated by the arrow. The wet treatment performer 130 may discharge a purified gas PUG through a secondary treatment of secondarily dissolving the primarily treated gas that may have passed through the reactor 120 in water-soluble water.

As indicated by the arrows, the purified gas PUG may be transported to the house scrubber device 200 through the first gas discharge pipe 20, the gas outlet 174, and the second gas discharge pipe 22. The first gas discharge pipe 20 may connect the gas outlet 174 to the wet treatment performer 130. The second gas discharge pipe 22 may connect the gas outlet 174 to the house scrubber device 200. The purified gas PUG transferred to the house scrubber device 200 may be further purified and discharged into the air.

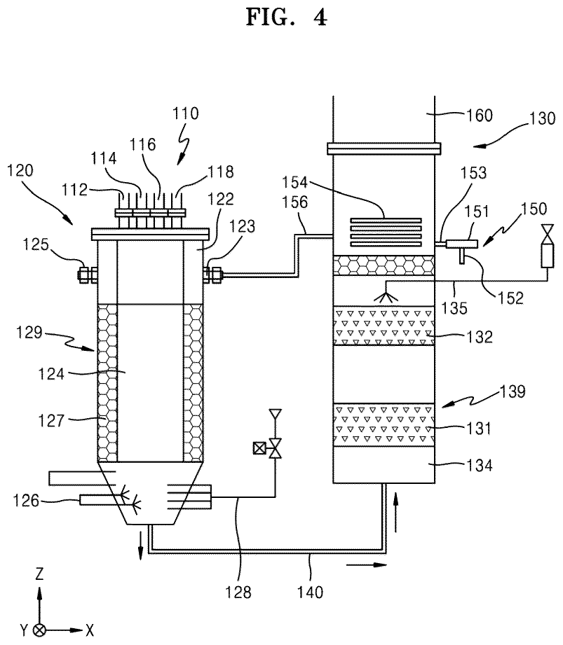

FIG. 4 is a cross-sectional view of a reactor and a wet treatment performer of a scrubber system showing a configuration according to an example embodiment. The scrubber system (100 in FIGS. 1 to 3) may include the reactor 120 and the wet treatment performer 130. The reactor 120 and wet treatment performer 130 shown in FIG. 4 may be employed in the scrubber system 100. The reactor 120 and the wet treatment performer 130 of FIG. 4 are example embodiments.

The scrubber system 100 may have components that perform a treatment process based on a burning type and a treatment process based on a wetting type. The reactor 120 may include an intake head 110 into which the harmful gas HFG from the manufacturing device (10 of FIGS. 1 to 3) may be injected, a burner 129 connected to the intake head 110, and a gas connection pipe 140 for transmitting a primary burning type treated gas from the burner 129 to a next wetting type process. The gas connection pipe 140 may correspond to the gas connection pipe 18 of FIGS. 1 to 3.

The intake head 110 of the reactor 120 may include a plurality of intakes 112, 114, 116, and 118, a head 122 for receiving the harmful gas HFG delivered via the intakes 112, 114, 116, and 118, a combustion air injection nozzle 125 and an air injection nozzle 123. The burner 129 of the reactor 120 may include a combustion chamber 124 surrounded by a heater 127. The air injection nozzle 123 may provide for temperature control.

The wet treatment performer 130 may include a wet cleaner 139 connected to the gas connection pipe 140 for secondarily treating a primarily burning type treated gas with a wetting type process, a cooling part 150 connected to the wet cleaner 139, and a gas discharge pipe 160 discharging a purified gas discharged from the wet cleaner 139 and the cooling part 150. The gas discharge pipe 160 may correspond to the gas discharge pipe 20 of FIGS. 1 to 3.

The wet cleaner 139 may include a primary dust collector 131, a circulation water sprayer 134, a secondary dust collector 132, and a freshwater sprayer 135. The cooling part 150 may include a cooler 151, a compressed air injector 152, a primary air injector 153, a cooling pipe 154, and a secondary air injector 156.

The compressed air injector 152 may be connected to one side of the cooler 151 to inject compressed air. The primary air injector 153 for injecting air cooled by the cooler 151 into the cooling pipe 154 above the wet cleaner 139 may be on the other side of the cooler 151. Also, the cooling pipe 154 may be installed above the wet cleaner 139 to receive cooled air from the primary air injector 153.

The harmful gas HFG discharged from the manufacturing device may be injected into the combustion chamber 124 through the intakes 112, 114, 116, and 118 connected to the head 122. The injected harmful gas HFG may be burned, oxidized, or thermally decomposed in the combustion chamber 124, thereby being primarily treated. The primarily treated gas may be injected into the wet cleaner 139 through the gas connection pipe 140. The gas connection pipe 140 may correspond to the gas connection pipe 18 of FIGS. 1 to 3.

The primarily treated gas may include some gas or dust particles that have not yet been treated. The circulation water spray 134 of the wet cleaner 139 sprays water to the primarily treated gas injected through the gas connection pipe 140, and the primarily treated gas sprayed with water passes through the primary dust collector 131 so that dust, such as powder, included in the primarily treated gas may be cleaned. In addition, by allowing the cleaned primarily treated gas to pass through the secondary dust collector 132 and the freshwater spray 135 once again, secondary cleaning may be performed more precisely.

Subsequently, the cleaned secondarily treated gas injects cold air generated in the cooler 151 of the cooling part 150 into the cooling pipe 154 through the primary air injector 153. The cooling pipe 154 may be spirally installed above the wet cleaner 139. The cleaned secondarily treated gas may be cooled while passing through the cooling pipe 154.

Therefore, dust or moisture contained in the cleaned secondarily treated gas may be condensed on a surface of the cooling pipe 154 at −40° C. to 5° C. to then fall to a lower end of the wet cleaner 139. As a result, the cleaned secondarily treated gas may be further cleaned so that a purified gas may be transferred to the gas discharge pipe 160.

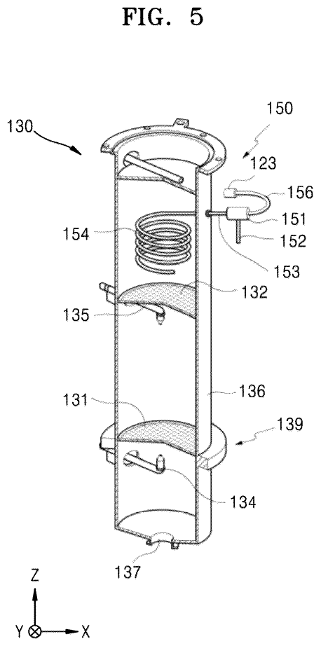

FIG. 5 is a partial, cross-sectional view of a detailed configuration of the wet treatment performer 130 shown in FIG. 4. FIG. 5 may be a diagram illustrating a coupling relationship between the wet cleaner 139 and the cooling part 150 constituting the wet treatment performer 130 of FIG. 4. The description provided above with respect to FIG. 4 will not be repeated, unless necessary, with respect to FIG. 5.

The wet treatment performer 130 may inject the primarily treated gas introduced from the burner (129 in FIG. 4) into a tower 136 of the wet cleaner 139. The wet treatment performer 130 treats a water-soluble gas in the primary dust collector 131 by using water sprayed from the circulation water spray 134 for the primarily treated gas injected into the tower 136.

The primary dust collector 131 and the secondary dust collector 132 may have, e.g., a mesh shape. In order to spray water to the primarily treated gas injected from the burner (129 in FIG. 4), the circulation water spray 134 may be installed below the primary dust collector 131.

In addition, the fresh water spray 135 may be installed below the secondary dust collector 132 to additionally treat the cleaned primarily treated gas that may have passed through the primary dust collecting 131. The cleaned primarily treated gas passing through the primary dust collector 131 passes through water by the fresh water spray 135 and the secondary dust collector 132 to be cleaned secondarily.

Subsequently, the secondarily treated gas cleaned by the above method passes through the cooling pipe 154 connected to the cooler 151 of the cooling part 150 through the primary air injector 153. Accordingly, the cleaned secondarily treated gas passing through the cooling pipe 154 may be cooled to room temperature of 30° C. or lower and further cleaned so that a purified gas may be discharged. The purified gas may be transferred to a gas discharge pipe (160 in FIG. 4).

The cooler 151 receives compressed air through the compressed air injector 152 to generate cooling air and hot air. The hot air generated by the cooler 151 may be injected into the combustion chamber (124 in FIG. 4) through the secondary air injector 156 of the burner 129 and the air injection nozzle 123.

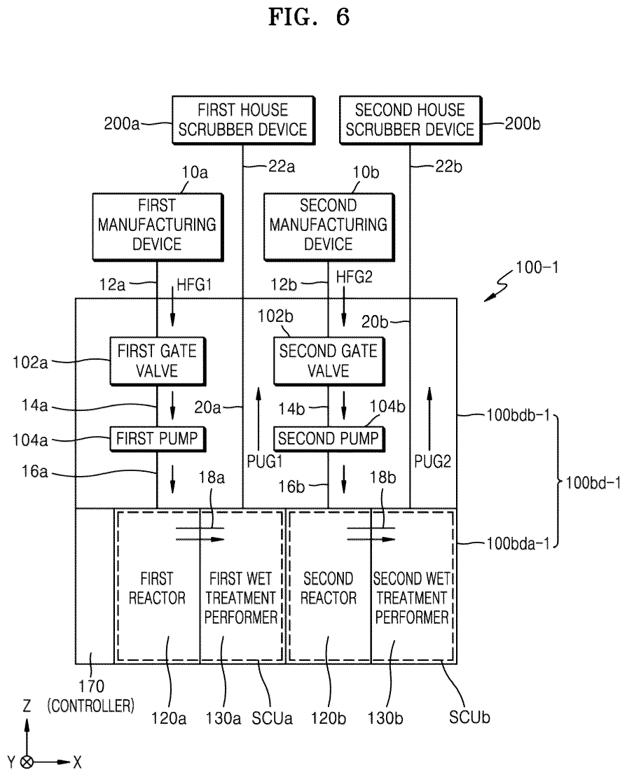

FIG. 6 is a schematic cross-sectional view of a scrubber system 100-1 according to an example embodiment. Compared to the scrubber system 100 of FIGS. 1 to 5, the scrubber system 100-1 may be substantially the same as the scrubber system 100 of FIGS. 1 to 5, except for first and second scrubbers SCUa and SCUb and first and second manufacturing devices 10a and 10b.

The scrubber system 100-1 shown in FIG. 6 may be a diagram corresponding to FIG. 2. In FIG. 6, the same or similar reference numerals as those in FIGS. 1 to 5 denote the same or similar members. The description provided above with respect to FIGS. 1 to 5 will not be repeated, unless necessary, with respect to FIG. 6.

The scrubber system 100-1 may include a body 100bd-1 including a lower body 100bda-1 and an upper body 100bdb-1. The lower body 100bda-1 and the upper body 100bdb-1 may respectively correspond to the lower body 100bda and the upper body 100bdb of FIG. 2.

The scrubber system 100-1 may include first and second scrubbers SCUa and SCUb located in the lower body 100bda-1. The first and second scrubbers SCUa and SCUb may be configured in the form of a chiffonier.

The first scrubber SCUa may include a first reactor 120a and a first wet treatment performer 130a. The first reactor 120a may be connected to the first wet treatment performer 130a by a first gas connection pipe 18a. The first scrubber SCUa may correspond to the scrubber SCU of FIG. 2. The first reactor 120a and the first wet treatment performer 130a may respectively correspond to the reactor 120 and the wet treatment performer 130 of FIG. 2.

The second scrubber SCUb may include a second reactor 120b and a second wet treatment performer 130b. The second reactor 120b may be connected to the second wet treatment performer 130b by a second gas connection pipe 18b. The scrubber system 100-1 may treat a harmful gas with the second scrubber SCUb to increase a discharge capacity of a purified gas.

In the scrubber system 100-1, the controller 170 may be located in the lower body 100bda-1. The controller 170 may be an element that mechanically and electrically controls all components of the scrubber system 100-1.

In the scrubber system 100-1, a first pump 104a and a second pump 104b may be in the upper body 100bdb-1. The first pump 104a and the second pump 104b may be on the first scrubber SCUa and the second scrubber SCUb, respectively. The first pump 104a and the second pump 104b may be above the first scrubber SCUa and the second scrubber SCUb in the Z direction, respectively.

The first pump 104a may inject a first harmful gas HFG1 from the first manufacturing device 10a into the first reactor 120a. The first scrubber SCUa may purify the first harmful gas HFG1 and discharge a first purified gas PUG1 to the outside of the upper body 100bdb-1. The second pump 104b may inject a second harmful gas HFG2 from the second manufacturing device 10b into the second reactor 120b. The second scrubber SCUa may purify the second harmful gas HFG2 and discharge a second purified gas PUG2 to the outside of the upper body 100bdb.

When the first pump 104a and the second pump 104b are respectively installed above the first scrubber SCUa and the second scrubber SCUb in the Z direction, respectively, the first harmful gas HFG1 and the second harmful gas HFG2 may have a good gas flow in the Z direction, so that a phenomenon in which foreign matter, such as powder, occurs in the gas supply pipes, e.g., the third gas supply pipe 16a and the sixth gas supply pipe 16b, to cause blockage may be avoided or suppressed.

The process of injecting the first harmful gas HFG1 and the second harmful gas HFG2 respectively from the first manufacturing device 10a and the second manufacturing device 10b into the scrubber system 100-1, and the process of discharging the first purified gas PUG1 and the second purified gas PUG2 to the outside respectively through the first scrubber SCUa and the second scrubber SCUb will now be described in detail.

The first harmful gas HFG1 discharged from the first manufacturing device 10a may flow into the scrubber system 100-1 through the first gas supply pipe 12a as indicated by the arrow. A first gate valve 102a may be connected to the first gas supply pipe 12a. The first gate valve 102a may be a valve that turns on or off the flow of the first harmful gas HFG1 introduced from the first gas supply pipe 12a or controls the amount of the first harmful gas HFG1.

The first gate valve 102a may be connected to the first pump 104a through the second gas supply pipe 14a. The second gas supply pipe 14a may connect the first gate valve 102a to the first pump 104a. The first harmful gas HFG1 passing through the first pump 104a may be injected into the first reactor 120a through the third gas supply pipe 16a. The third gas supply pipe 16a may connect the first pump 104a to the first reactor 120a.

The first reactor 120a may primarily burn the first harmful gas HFG1 and transfer the burned first harmful gas HFG1 to the first wet treatment performer 130a through the first gas connection pipe 18a as indicated by the arrow. The first wet treatment performer 130a may secondarily dissolve the primarily treated gas that may have passed through the first reactor 120a in water-soluble water for a secondary treatment, and discharge a first purified gas PUG1.

The first purified gas PUG1 may be discharged through the first gas discharge pipe 20a as indicated by the arrow. The first purified gas PUG1 discharged through the first gas discharge pipe 20a may be discharged into the air through the first house scrubber device 200a through the second gas discharge pipe 22a. The first house scrubber device 200a may be a gas purifying device installed in a manufacturing plant.

Meanwhile, the second harmful gas HFG2 discharged from the second manufacturing device 10b may flow into the scrubber system 100-1 through the fourth gas supply pipe 12b as indicated by the arrow. The second gate valve 102b may be connected to the fourth gas supply pipe 12b. The second gate valve 102b may be a valve that turns on or off the flow of the second harmful gas HFG2 introduced from the fourth gas supply pipe 12b or controls the amount of the second harmful gas HFG2.

The second gate valve 102b may be connected to the second pump 104b through the fifth gas supply pipe 14b. The fifth gas supply pipe 14b may connect the second gate valve 102b to the second pump 104b. The second harmful gas HFG2 passing through the second pump 104b may be injected into the second reactor 120b through the sixth gas supply pipe 16b. The sixth gas supply pipe 16b may connect the second pump 104b to the second reactor 120b.

The second reactor 120b may primarily burn the second harmful gas HFG2 and transfer the burned second harmful gas HFG2 to the second wet treatment performer 130b through the second gas connection pipe 18b as indicated by the arrow. The second wet treatment performer 130b may dissolve the primarily treated gas that may have passed through the second reactor 120b in water-soluble water for a secondary treatment, and discharge a second purified gas PUG2.

The second purified gas PUG2 may be discharged to the third gas discharge pipe 20b as indicated by the arrow. The second purified gas PUG2 discharged to the third gas discharge pipe 20b may be discharged into the air through the second house scrubber device 200b through the fourth gas discharge pipe 22b. The second house scrubber device 200b may be a gas purifying device installed in a manufacturing plant.

The scrubber system 100-1 may include the first and second scrubbers SCUa and SCUb, the first and second manufacturing devices 10a and 10b, and the first and second pumps 104a and 104b to thereby easily increase a gas purification capacity.

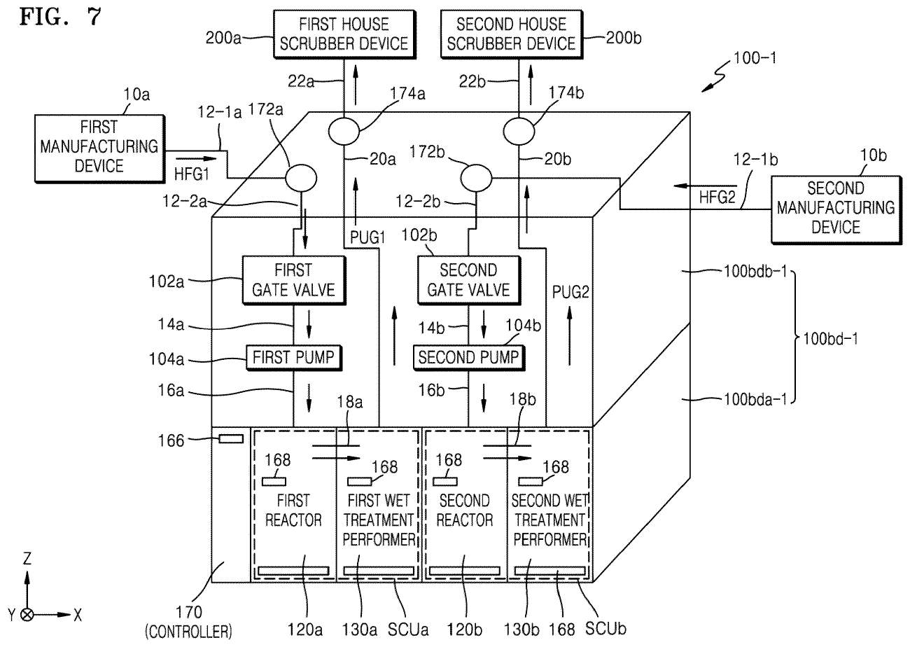

FIG. 7 is a perspective, schematic view of a scrubber system 100-1 according to an example embodiment. Compared to the scrubber system 100 of FIGS. 1 to 5, the scrubber system 100-1 may be substantially the same as the scrubber system 100 of FIGS. 1 to 5, except for the first and second scrubbers SCUa and SCUb and the first and second manufacturing devices 10a and 10b.

The scrubber system 100-1 of FIG. 7 may be a perspective view of FIG. 6. The scrubber system 100-1 shown in FIG. 7 may be a diagram corresponding to FIG. 3. In FIG. 7, the same or similar reference numerals as those in FIGS. 1 to 6 denote the same or similar members. The description provided above with respect to FIGS. 1 to 6 will not be repeated, unless necessary, with respect to FIG. 7.

The scrubber system 100-1 may include the body 100bd-1 including the lower body 100bda-1 and the upper body 100bdb-1. The body 100bd-1 may have a rectangular parallelepiped shape. The body 100bd-1 may have the same size as that of the body 100bd of FIG. 3.

The scrubber system 100-1 may include first and second scrubbers SCUa and SCUb located in the lower body 100bda-1. The first and second scrubbers SCUa and SCUb may be configured in the form of a chiffonier. The first scrubber SCUa may include a first reactor 120a and a first wet treatment performer 130a. The first reactor 120a may be connected to the first wet treatment performer 130a by a first gas connection pipe 18a. The second scrubber SCUb may include a second reactor 120b and a second wet treatment performer 130b. The second reactor 120b may be connected to the second wet treatment performer 130b by a second gas connection pipe 18b.

As described above, the first and second scrubbers SCUa and SCUb may be configured in the form of a chiffonier. The first reactor 120a and the second reactor 120b may be pulled out in the reverse Y direction using a handle 168, and may be pushed back in the Y direction again using the handle 168. Like the first reactor 120a and the second reactor 120b, the first wet treatment performer 130a and the second wet treatment performer 130b may be pulled out in the reverse Y direction using the handle 168, and then pushed back in the Y direction by using the handle 168.

The scrubber system 100-1 may include a controller 170 located in the lower body 100bda The controller 170 may be configured in the form of a chiffonier. The controller 170 may be pulled out in the reverse Y direction using the handle 166, and may be pushed back in the Y direction using the handle 166 again.

In the scrubber system 100-1, a first pump 104a and a second pump 104b may be located in the upper body 100bdb-1. The first pump 104a and the second pump 104b may be located in the upper body 100bdb-1 on the first and second scrubbers SCUa and SCUb. The first pump 104a and the second pump 104b may be located above the first and second scrubbers SCUa and SCUb in the Z direction.

The first pump 104a may inject the first harmful gas HFG1 from the first manufacturing device 10a into the first reactor 120a. The first scrubber SCUa may purify the first harmful gas HFG1 and discharge the first purified gas PUG1 to the outside of the upper body 100bdb. The second pump 104b may inject the second harmful gas HFG2 from the second manufacturing device 10b into the second reactor 120b. The second scrubber SCUa may purify the second harmful gas HFG2 and discharge the second purified gas PUG2 to the outside of the upper body 100bdb.

When the first pump 104a and the second pump 104b are installed above the first scrubber SCUa and the second scrubber SCUb in the Z direction, respectively, the first harmful gas HFG1 and the second harmful gas HFG2 have a good gas flow in the Z direction, so that a phenomenon in which foreign matter, such as powder, occurs in the gas supply pipes, e.g., the third gas supply pipe 16a and the sixth gas supply pipe 16b, may be solved or eliminated.

The upper body 100bdb-1 may include a first gas inlet 172a, a second gas inlet 172b, a first gas outlet 174a, and a second gas outlet 174b. The first harmful gas HFG1 discharged from the first manufacturing device 10a may be introduced into the scrubber system 100-1 through a first sub-gas supply pipe 12-1a and the first gas inlet 172a as indicated by the arrows. A second sub-gas supply pipe 12-2a may be connected to the first gas inlet 172a. The first sub-gas supply pipe 12-1a and the second sub-gas supply pipe 12-2a are referred to as the first gas supply pipe 12a for convenience in the above description.

A first gate valve 102a, a second gas supply pipe 14a, a first pump 104a, a third gas supply pipe 16a, and a first reactor 120a may be sequentially connected to the second sub-gas supply pipe 12-2a. The first reactor 120a may primarily burn the first harmful gas HFG1 and transfer the first harmful gas HFG1 to the first wet treatment performer 130a through the first gas connection pipe 18a as indicated by an arrow. The first wet treatment performer 130a may discharge the first purified gas PUG1 through a secondary treatment process of secondarily dissolving the primarily treated gas passing through the first reactor 120a in water, i.e., render the gas water-soluble.

As indicated by the arrows, the first purified gas PUG1 may be transferred to the first house scrubber device 200a through the first gas discharge pipe 20a, the first gas outlet 174a, and the second gas discharge pipe 22a. The first gas discharge pipe 20a may connect the first gas outlet 174a to the first wet treatment performer 130a. The second gas discharge pipe 22a may connect the first gas outlet 174a to the first house scrubber device 200a.

Meanwhile, the second harmful gas HFG2 discharged from the second manufacturing device 10b may be introduced into the scrubber system 100-1 through the third sub-gas supply pipe 12-1b and the second gas inlet 172b as indicated by the arrows. The fourth sub-gas supply pipe 12-2b may be connected to the second gas inlet 172b. The third sub-gas supply pipe 12-1b and the fourth sub-gas supply pipe 12-2b are referred to as the fourth gas supply pipe 12b for convenience in the above description.

The second gate valve 102b, the fifth gas supply pipe 14b, the second pump 104b, the sixth gas supply pipe 16b, and the second reactor 120b may be sequentially connected to the fourth sub-gas supply pipe 12-2b. The second reactor 120b may primarily burn the second harmful gas HFG2 and transfer the burnt second harmful gas HFG2 to the second wet treatment performer 130b through the second gas connection pipe 18b as indicated by the arrows. The second wet treatment performer 130b may discharge the second purified gas PUG2 through a secondary treatment process of secondarily dissolving the primarily treated gas that may have passed through the second reactor 120b in water, i.e., render the gas water-soluble.

As indicated by the arrows, the second purified gas PUG2 may be transferred to the second house scrubber device 200b through the third gas discharge pipe 20b, the second gas outlet 174b, and the fourth gas discharge pipe 22b. The third gas discharge pipe 20b may connect the second gas outlet 174b to the second wet treatment performer 130b. The fourth gas discharge pipe 22b may connect the second gas outlet 174b to the second house scrubber device 200b.

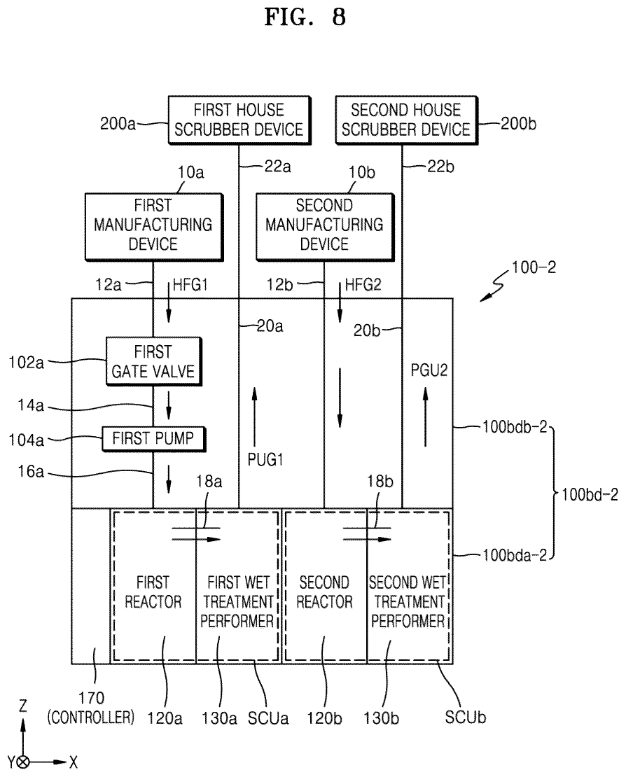

FIG. 8 is a cross-sectional, schematic view of a scrubber system 100-2 according to an example embodiment. Compared to the scrubber system 100-1 in FIGS. 6 and 7, the scrubber system 100-2 may be substantially the same as the scrubber system 100-1 of FIGS. 6 and 7, except that the scrubber system 100-2 does not include the second gate valve (102b in FIGS. 6 and 7) and the second pump (104b in FIGS. 6 and 7). The description provided above with respect to FIGS. 6 and 7 will not be repeated, unless necessary, with respect to FIG. 8.

The scrubber system 100-2 may include a body 100bd-2 including a lower body 100bda-2 and an upper body 100bdb-2. The scrubber system 100-2 may include first and second scrubbers SCUa and SCUb located in the lower body 100bda-2. The first and second scrubbers SCUa and SCUb may be configured in the form of a chiffonier.

The first scrubber SCUa may include a first reactor 120a and a first wet treatment performer 130a. The first reactor 120a may be connected to the first wet treatment performer 130a by a first gas connection pipe 18a.

The second scrubber SCUb may include a second reactor 120b and a second wet treatment performer 130b. The second reactor 120b may be connected to the second wet treatment performer 130b by the second gas connection pipe 18b. In the scrubber system 100-2, the controller 170 may be located in the lower body 100bda-2.

In the scrubber system 100-2, the first pump 104a may be located in the upper body 100bdb-2. The first pump 104a may be above the first scrubber SCUa in the Z direction, so that the first harmful gas HFG1 may have a good gas flow in the Z direction, and thus, a phenomenon in which foreign matter, such as powder, occurs in the gas supply pipes, e.g., the third gas supply pipe 16a, may be suppressed, prevented or eliminated.

The first harmful gas HFG1 discharged from the first manufacturing device 10a may flow into the scrubber system 100-2 through the first gas supply pipe 12a as indicated by the arrow. The first gate valve 102a, the second gas supply pipe 14a, the first pump 104a, and the first reactor 120a may be sequentially connected to the first gas supply pipe 12a. The first harmful gas HFG1 passing through the first pump 104a may be injected into the first reactor 120a through the third gas supply pipe 16a.

The first reactor 120a may primarily burn the first harmful gas HFG1 and transfer the burnt first harmful gas HFG1 to the first wet treatment performer 130a through the first gas connection pipe 18a as indicated by the arrow. The first wet treatment performer 130a may discharge the first purified gas PUG1 through a secondary treatment of dissolving the primarily treated gas that may have passed through the first reactor 120a in water, i.e., render the harmful gas water soluble. The first purified gas PUG1 may be discharged into the air through the first house scrubber device 200a through the first gas discharge pipe 20a and the second gas discharge pipe 22a.

The second harmful gas HFG2 discharged from the second manufacturing device 10b may be directly injected into the second reactor 120b of the scrubber system 100-2 through the fourth gas supply pipe 12b as indicated by the arrows.

The second reactor 120b may primarily burn the second harmful gas HFG2 and transfer the burnt second harmful gas HFG2 to the second wet treatment performer 130b through the second gas connection pipe 18b as indicated by the arrow. The second wet treatment performer 130b may perform secondary treatment of dissolving the primarily treated gas that may have passed through the second reactor 120b in water, i.e., render the harmful gas water soluble, and discharge the second purified gas PUG2.

As indicated by the arrow, the second purified gas PUG2 may be discharged into the air through the second house scrubber device 200b through the third gas discharge pipe 20b and the fourth gas discharge pipe 22b.

The scrubber system 100-2 may include the first and second scrubbers SCUa and SCUb, the first and second manufacturing devices 10a and 10b, and the first pump 104a to efficiently perform gas purification, while increasing capacity of gas purification.

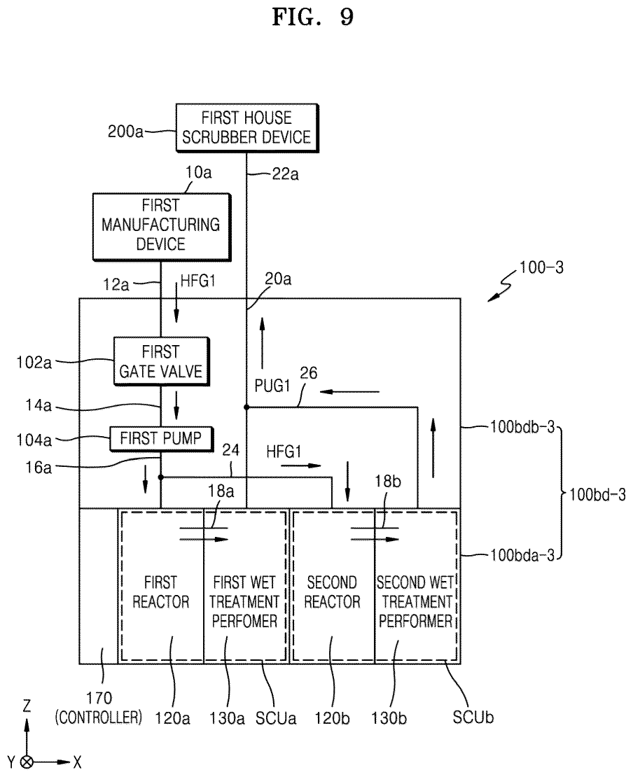

FIG. 9 is a cross-sectional, schematic view of a scrubber system 100-3 according to an example embodiment. Compared to the scrubber system 100-2 of FIG. 8, the scrubber system 100-3 may be substantially the same as the scrubber system 100-2, except for a configuration for purification of the second harmful gas (HAF2 of FIG. 8) supplied through the second manufacturing device (10b in FIG. 8). The description provided above with respect to FIG. 8 will not be repeated, unless necessary, with respect to FIG. 9.

The scrubber system 100-3 may include a body 100bd-3 including a lower body 100bda-3 and an upper body 100bdb-3. The scrubber system 100-3 may include first and second scrubbers SCUa and SCUb located in the lower body 100bda-3. The first and second scrubbers SCUa and SCUb may be configured in the form of a chiffonier.

The first scrubber SCUa may include the first reactor 120a and the first wet treatment performer 130a. The first reactor 120a may be connected to the first wet treatment performer 130a by the first gas connection pipe 18a.

The second scrubber SCUb may include the second reactor 120b and the second wet treatment performer 130b. The second reactor 120b may be connected to the second wet treatment performer 130b by a second gas connection pipe 18b. In the scrubber system 100-3, the controller 170 may be located in the lower body 100bda-2.

In the scrubber system 100-3, the first pump 104a may be located in the upper body 100bdb-3. The first pump 104a may be above the first scrubber SCUa in the Z direction, so that the first harmful gas HFG1 may have a good gas flow in the Z direction, and thus, a phenomenon in which foreign matter, such as powder, occurs in the gas supply pipes, e.g., the third gas supply pipe 16a, may be suppressed, prevented or eliminated.

The first harmful gas HFG1 discharged from the first manufacturing device 10a may flow into the scrubber system 100-3 through the first gas supply pipe 12a as indicated by the arrow. The first gate valve 102a, the second gas supply pipe 14a, the first pump 104a, and the first reactor 120a may be sequentially connected to the first gas supply pipe 12a.

The first harmful gas HFG1 passing through the first pump 104a may be injected into the first reactor 120a through the third gas supply pipe 16a. A seventh gas supply pipe 24 connected to the second reactor 120b may be connected to the third gas supply pipe 16a. The first harmful gas HFG1 passing through the first pump 104a may be injected into the second reactor 120b through the seventh gas supply pipe 24. The first harmful gas HFG1 may be injected into the first reactor 120a or the second reactor 120b.

The first reactor 120a may primarily burn the first harmful gas HFG1 and transfer the burnt first harmful gas HFG1 to the first wet treatment performer 130a through the first gas connection pipe 18a as indicated by the arrow. The first wet treatment performer 130a may discharge the first purified gas PUG1 through a secondary treatment of dissolving the primarily treated gas that may have passed through the first reactor 120a in water, i.e., render the harmful gas water soluble.

The first purified gas PUG1 discharged from the first wet treatment performer 130a may be discharged into the air through the first house scrubber device 200a through the first gas discharge pipe 20a and the second gas discharge pipe 22a.

The second reactor 120b may primarily burn the first harmful gas HFG1 and transfer the burnt first harmful gas HFG1 to the second wet treatment performer 130b through the second gas connection pipe 18b as indicated by the arrow. The second wet treatment performer 130b may discharge the first purified gas PUG1 through a secondary treatment of dissolving the primarily treated gas that may have passed through the second reactor 120b in water, i.e., render the harmful gas water soluble.

The first purified gas PUG1 discharged from the second wet treatment performer 130b may pass through the fifth gas discharge pipe 26, the first gas discharge pipe 20a, and the second gas discharge pipe 22a and may then be discharged into the air through the first house scrubber device 200a. The fifth gas discharge pipe 26 may be connected to the first gas discharge pipe 20a.

In the scrubber system 100-3, the first harmful gas HFG1 may be injected into the first reactor 120a or the second reactor 120b, and the first harmful gas HFG1 may be purified in the first wet treatment performer 130a or the second wet treatment performer 130b, thereby increasing a capacity of gas purification.

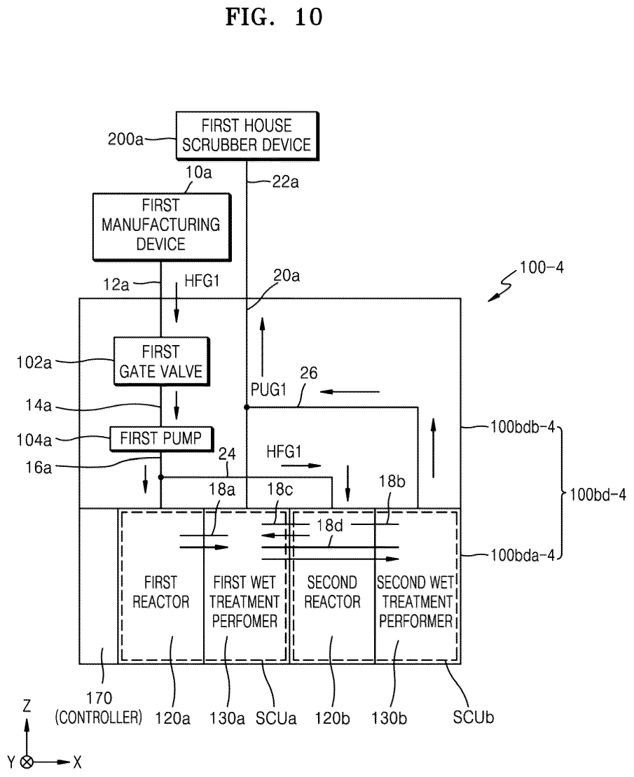

FIG. 10 is a cross-sectional, schematic view of a scrubber system 100-4 according to an example embodiment. Compared to the scrubber system 100-3 of FIG. 9, the scrubber system 100-4 may be substantially the same as the scrubber system 100-3 of FIG. 9, except that gas connection pipes 18a, 18b, 18c, and 18d connecting the first reactor 120a, the first wet treatment performer 130a, the second reactor 120b, and the second wet treatment performer 130b may be different. The description provided above with respect to FIG. 9 will not be repeated, unless necessary, with respect to FIG. 10.

The scrubber system 100-4 may include a body 100bd-4 including a lower body 100bda-4 and an upper body 100bdb-4. The scrubber system 100-4 may include first and second scrubbers SCUa and SCUb located in the lower body 100bda-4. The first and second scrubbers SCUa and SCUb may be configured in the form of a chiffonier.

The first scrubber SCUa may include the first reactor 120a and the first wet treatment performer 130a. The first reactor 120a may be connected to the first wet treatment performer 130a by a first gas connection pipe 18a.

The second scrubber SCUb may include the second reactor 120b and the second wet treatment performer 130b. The second reactor 120b may be connected to the second wet treatment performer 130b by the second gas connection pipe 18b. In the scrubber system 100-4, the controller 170 may be located in the lower body 100bda-4.

The scrubber system 100-4 may include the third gas connection pipe 18c connecting the second reactor 120b to the first wet treatment performer 130a and the fourth gas connection pipe 18d connecting the first wet treatment performer 130a to the second wet treatment performer 130b.

In the scrubber system 100-4, the first pump 104a may be located in the upper body 100bdb-4. The first pump 104a may be above the first scrubber SCUa in the Z direction, so that the first harmful gas HFG1 may have a good gas flow in the Z direction, and thus, a phenomenon in which foreign matter, such as powder, occurs in the gas supply pipes, e.g., the third gas supply pipe 16a, may be suppressed, prevented or eliminated.

The first harmful gas HFG1 discharged from the first manufacturing device 10a may flow into the scrubber system 100-4 through the first gas supply pipe 12a as indicated by the arrow. The first gate valve 102a, the second gas supply pipe 14a, the first pump 104a, and the first reactor 120a may be sequentially connected to the first gas supply pipe 12a.

The first harmful gas HFG1 passing through the first pump 104a may be injected into the first reactor 120a through the third gas supply pipe 16a. The seventh gas supply pipe 24 connected to the second reactor 120b may be connected to the third gas supply pipe 16a.

The first harmful gas HFG1 passing through the first pump 104a may be injected into the second reactor 120b through the seventh gas supply pipe 24. The first harmful gas HFG1 may be injected into the first reactor 120a or the second reactor 120b.

The first reactor 120a may primarily burn the first harmful gas HFG1 and transfer the burnt first harmful gas HFG1 to the first wet treatment performer 130a through the first gas connection pipe 18a as indicated by the arrow. The first wet treatment performer 130a may discharge the first purified gas PUG1 through a secondary treatment of dissolving the primarily treated gas that may have passed through the first reactor 120a in water, i.e., dissolve the harmful components of the gas in water.

The second reactor 120b may primarily burn the first harmful gas HFG1 supplied through the seventh gas supply pipe 24 and transfer the burnt first harmful gas HFG1 to the second wet treatment performer 130b through the second gas connection pipe 18b as indicated by the arrow.

The second reactor 120b may primarily burn the first harmful gas HFG1 and transfer the burnt first harmful gas HFG1 to the first wet treatment performer 130a through the third gas connection pipe 18c as indicated by the arrow. When the secondary treatment is insufficient in the first wet treatment performer 130a, the gas secondarily treated in the first wet treatment performer 130a 130 may be secondarily treated in the second wet treatment performer 130b through the fourth gas connection pipe 18d.

The first purified gas PUG1 discharged from the first wet treatment performer 130a may pass through the first gas discharge pipe 20a and the second gas discharge pipe 22a and may then be discharged into the air through the first house scrubber device 200a. The first purified gas PUG1 discharged from the second wet treatment performer 130b may pass through the fifth gas discharge pipe 26, the first gas discharge pipe 20a, and the second gas discharge pipe 22a and may then be discharged into the air through the first house scrubber device 200a.

The first wet treatment performer 130a and the second wet treatment performer 130b may discharge the first purified gas PUG1 through a secondary treatment of dissolving the primarily treated gas passing through the first reactor 120a or the second reactor 120b in water, i.e., dissolve harmful components of the gas in water.

In the scrubber system 100-4, the first harmful gas HFG1 may be injected into the first reactor or the second reactor, and the first harmful gas HFG1 may be purified in the first wet treatment performer 130a and/or the second wet treatment performer 130b, thereby increasing a capacity of gas purification.

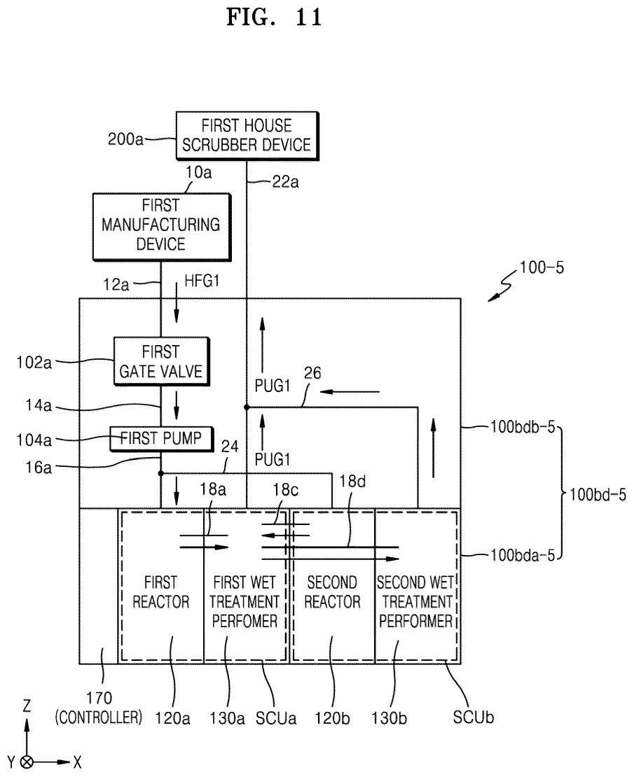

FIG. 11 is a cross-sectional, schematic view of a scrubber system 100-5 according to an example embodiment. Compared to the scrubber system 100-4 of FIG. 10, the scrubber system 100-5 may be substantially the same as the scrubber system 100-4 of FIG. 10 except that the second gas connection pipe (18b in FIG. 10) may not be installed. The description provided above with respect to FIG. 10 will not be repeated, unless necessary, with respect to FIG. 11.

The scrubber system 100-5 may include a body 100bd-5 including a lower body 100bda-5 and an upper body 100bdb-5. The scrubber system 100-5 may include first and second scrubbers SCUa and SCUb located in the lower body 100bda-5. The first and second scrubbers SCUa and SCUb may be configured in the form of a chiffonier.

The first scrubber SCUa may include the first reactor 120a and the first wet treatment performer 130a. The first reactor 120a may be connected to the first wet treatment performer 130a by the first gas connection pipe 18a. The second scrubber SCUb may include the second reactor 120b and the second wet treatment performer 130b. In the scrubber system 100-5, the controller 170 may be located in the lower body 100bda-5.

The scrubber system 100-5 may include the third gas connection pipe 18c connecting the second reactor 120b to the first wet treatment performer 130a and the fourth gas connection pipe 18d connecting the first wet treatment performer 130a to the second wet treatment performer 130b.

In the scrubber system 100-5, the first pump 104a may be located in the upper body 100bdb-5. The first pump 104a may be above the first scrubber SCUa in the Z direction, so that the first harmful gas HFG1 may have a good gas flow in the Z direction, and thus, a phenomenon in which foreign matter, such as powder, occurs in the gas supply pipes, e.g., the third gas supply pipe 16a, may be suppressed, prevented or eliminated.

The first harmful gas HFG1 discharged from the first manufacturing device 10a may flow into the scrubber system 100-5 through the first gas supply pipe 12a as indicated by the arrow. The first gate valve 102a, the second gas supply pipe 14a, the first pump 104a, and the first reactor 120a may be sequentially connected to the first gas supply pipe 12a.

The first harmful gas HFG1 passing through the first pump 104a may be injected into the first reactor 120a through the third gas supply pipe 16a. The seventh gas supply pipe 24 connected to the second reactor 120b may be connected to the third gas supply pipe 16a.

The first harmful gas HFG1 passing through the first pump 104a may be injected into the second reactor 120b through the seventh gas supply pipe 24. The first harmful gas HFG1 may be injected into the first reactor 120a or the second reactor 120b.

The first reactor 120a may primarily burn the first harmful gas HFG1 and transfer the burnt first harmful gas HFG1 to the first wet treatment performer 130a through the first gas connection pipe 18a as indicated by the arrow. The first wet treatment performer 130a may discharge the first purified gas PUG1 through a secondary treatment of dissolving the primarily treated gas that may have passed through the first reactor 120a in water, i.e., dissolve the harmful components of the gas in water.

The second reactor 120b may primarily burn the first harmful gas HFG1 and transfer the burnt first harmful gas HFG1 to the first wet treatment performer 130a through the third gas connection pipe 18c as indicated by the arrow. When the secondary treatment is insufficient in the first wet treatment performer 130a, the gas secondarily treated in the first wet treatment performer 130 may be secondarily treated in the second wet treatment performer 130b through the fourth gas connection pipe 18d.

The first purified gas PUG1 discharged from the first wet treatment performer 130a may pass through the first gas discharge pipe 20a and the second gas discharge pipe 22a and may then be discharged into the air through the first house scrubber device 200a. The first purified gas PUG1 discharged from the second wet treatment performer 130b may pass through the fifth gas discharge pipe 26, the first gas discharge pipe 20a, and the second gas discharge pipe 22a and may then be discharged into the air through the first house scrubber device 200a.

The first wet treatment performer 130a and the second wet treatment performer 130b may discharge the first purified gas PUG1 through a secondary treatment of dissolving the primarily treated gas passing through the first reactor 120a or the second reactor 120b in water, i.e., dissolve the harmful components of the gas in water.

In the scrubber system 100-5, the first harmful gas HFG1 may be injected into the first reactor or the second reactor, and the first harmful gas HFG1 may be purified in the first wet treatment performer 130a and/or the second wet treatment performer 130b, thereby increasing a capacity of gas purification.

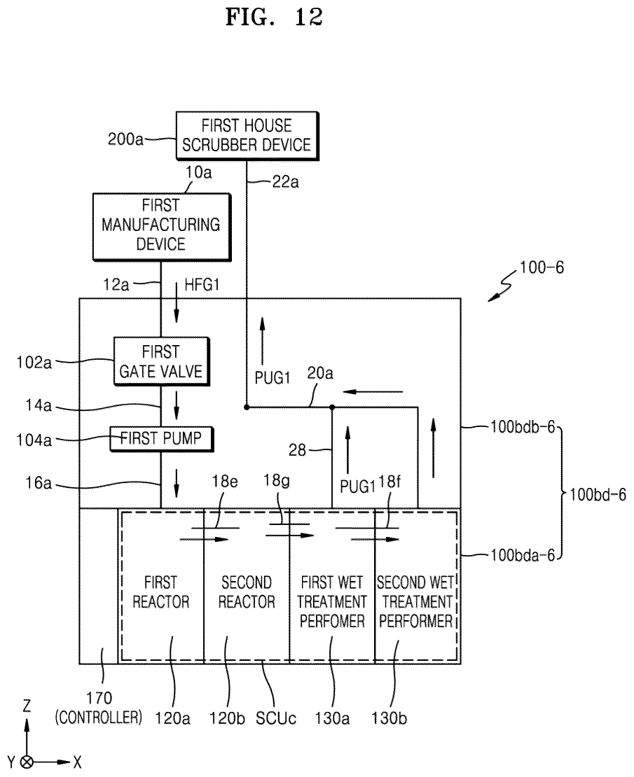

FIG. 12 is a cross-sectional, schematic view of a scrubber system 100-6 according to an example embodiment. Compared to the scrubber system 100-3 of FIG. 9, the scrubber system 100-6 may be substantially the same as the scrubber system 100-3 of FIG. 9, except that the configuration of the scrubber SCUc may be different and the sixth gas discharge pipe 28 may be further installed. The description provided above with respect to FIG. 11 will not be repeated, unless necessary, with respect to FIG. 12.

The scrubber system 100-6 may include a body 100bd-6 including a lower body 100bda-6 and an upper body 100bdb-6. In the scrubber system 100-6, the controller 170 may be located in the lower body 100bda-6. The scrubber system 100-6 may include a scrubber SCUc (indicated by dash lines) located in the lower body 100bda-6. The scrubber SCUc may be configured in the form of a chiffonier.

The scrubber SCUc may include the reactors 120a and 120b and the wet treatment performers 130a and 130b. e.g., the scrubber SCUc may include the first reactor 120a, the second reactor 120b, the first wet treatment performer 130a, and the second wet treatment performer 130b. The second reactor 120b may be installed on one side of the first reactor 120a. The second wet treatment performer 130b may be installed on one side of the first wet treatment performer 130a.

The scrubber system 100-6 connects a fifth gas connection pipe 18e connecting the first reactor 120a to the second reactor 120b, a sixth gas connection pipe 18f connecting the first wet treatment performer 130a to the second wet treatment performer 130b, and a seventh gas connection pipe 18g connecting the second reactor 120b to the first wet treatment performer 130a.

In the scrubber system 100-6, the first pump 104a may be located in the upper body 100bdb-6. The first pump 104a may be above the scrubber SCUc in the Z direction, so that the first harmful gas HFG1 may have a good gas flow in the Z direction, and thus, a phenomenon in which foreign matter, such as powder, occurs in the gas supply pipes, e.g., the third gas supply pipe 16a, may be suppressed, prevented or eliminated.

The first harmful gas HFG1 discharged from the first manufacturing device 10a may flow into the scrubber system 100-6 through the first gas supply pipe 12a as indicated by the arrow. The first gate valve 102a, the second gas supply pipe 14a, the first pump 104a, and the first reactor 120a may be sequentially connected to the first gas supply pipe 12a.

The first harmful gas HFG1 passing through the first pump 104a may be injected into the first reactor 120a through the third gas supply pipe 16a. The first reactor 120a may primarily burn the first harmful gas HFG1. In some embodiments, when the first reactor 120a is not able to treat the first harmful gas HFG1 or may have a small treatment capacity, the first reactor 120a may transfer the first harmful gas HFG1 to the second reactor 120b through the fifth gas connection pipe 18e to burn the first harmful gas HFG1.

The second reactor 120b may transfer the primarily burned first harmful gas HFG1 to the first wet treatment performer 130a through the seventh gas connection pipe 18g as indicated by the arrow. The first wet treatment performer 130a may discharge the first purified gas PUG1 through a secondary treatment of dissolving the primarily treated gas that may have passed through the second reactor 120b in water, i.e., dissolve the harmful components of the gas in water. When the secondary treatment is insufficient in the first wet treatment performer 130a, the gas secondarily treated in the first wet treatment performer 130a may be secondarily treated in the second wet treatment performer 130b by transfer through the sixth gas connection pipe 18f.

The first purified gas PUG1 discharged from the first wet treatment performer 130a may be injected into the first house scrubber device 200a through the sixth gas discharge pipe 28, the first gas discharge pipe 20a, and the second gas discharge pipe 22a, may be released to the atmosphere. The first purified gas PUG1 discharged from the second wet treatment performer 130b may pass through the first gas discharge pipe 20a and the second gas discharge pipe 22a and may then be discharged into the air through the first house scrubber device 200a.

In the scrubber system 100-6, the first harmful gas HFG1 may be injected into the first reactor, and the first harmful gas HFG1 may be purified in the first wet treatment performer 130a and/or the second wet treatment performer 130b, thereby increasing a capacity of gas purification.

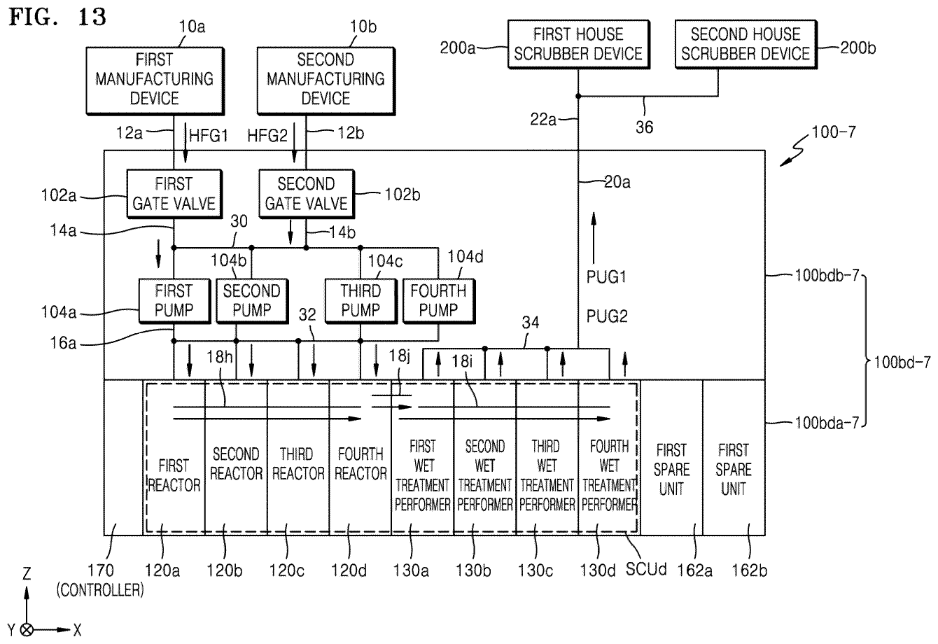

FIG. 13 is a cross-sectional, schematic view of a scrubber system 100-7 according to an example embodiment. Compared to the scrubber system 100-6 of FIG. 12, the scrubber system 100-7 may be substantially the same as the scrubber system 100-6, except that a configuration of a scrubber SCUd may be different and a plurality of pumps 104a, 104b, 104c, 104d may be installed in the upper body 100bdb-7. The description provided above with respect to FIG. 12 will not be repeated, unless necessary, with respect to FIG. 13.

The scrubber system 100-7 may include a body 100bd-7 including a lower body 100bda-7 and an upper body 100bdb-7. In the scrubber system 100-7, the controller 170 may be located in the lower body 100bda-7.

The scrubber system 100-7 may include the scrubber SCUd (indicated with dash lines) located in the lower body 100bda-7. The scrubber system 100-7 may further include a plurality of spare installers 162a and 162b for installing an additional scrubber on the lower body 100bda-7. The scrubber SCUd and the spare installers 162a and 162b may be configured in the form of a chiffonier.

The scrubber SCUd may include a plurality of reactors 120a, 120b, 120c, and 120d and a plurality of wet treatment performers 130a, 130b, 130c, and 130d. In an implementation, the scrubber SCUd may include a first reactor 120a, a second reactor 120b, a third reactor 120c, a fourth reactor 120d, a first wet treatment performer 130a, a second wet treatment performer 130b, a third wet treatment performer 130c, and a fourth wet treatment performer 130d. The first to fourth reactors 120a, 120b, 120c, and 120d may be adjacent to each other. The first to fourth wet treatment performers 130a, 130b, 130c, and 130d may be adjacent to each other.

The scrubber system 100-7 may include an eighth gas connection pipe 18h connecting the first to fourth reactors 120a, 120b, 120c, and 120d, in succession, a ninth gas connection pipe 18i connecting the first to fourth wet treatment performers 130a, 130b, and 130c, 130d, in succession, and a tenth gas connection pipe 18j connecting the fourth reactor 120d to the first wet treatment performer 130a. The eighth gas connection pipe 18h connects the reactors in succession such that gas may be passed from any reactor to any other reactor. The ninth gas connection pipe 18i connects the wet treatment performers in succession such that gas may be passed from any wet treatment performer to any other wet treatment performer.

In the scrubber system 100-7, the first to fourth pumps 104a, 104b, 104c, and 104d may be located in the upper body 100bdb-7. The first to fourth pumps 104a, 104b, 104c, and 104d may be above the scrubber SCUd in the Z direction, so that the first harmful gas HFG1 and the second harmful gas HFG2 may have a good gas flow in the Z direction, and thus, a phenomenon in which foreign matter, such as powder, occurs in the gas supply pipe 16a may be suppressed, prevented or eliminated.

The first harmful gas HFG1 discharged from the first manufacturing device 10a may flow into the scrubber system 100-7 through the first gas supply pipe 12a as indicated by the arrow. The first gate valve 102a may be connected to the first gas supply pipe 12a. The first harmful gas HFG1 passing through the first gate valve 102a may be injected into at least any one of the first to fourth pumps 104a, 104b, 104c, and 104d through the second gas supply pipe 14a and the eighth gas supply pipe 30.

The second harmful gas HFG2 discharged from the second manufacturing device 10b may flow into the scrubber system 100-7 through the fourth gas supply pipe 12b as indicated by the arrow. The second gate valve 102b may be connected to the fourth gas supply pipe 12b. The second harmful gas HFG2 passing through the second gate valve 102b may be injected into at least any one of the first to fourth pumps 104a, 104b, 104c, and 104d through the fifth gas supply pipe 14b and the eighth gas supply pipe 30.

The first and second harmful gases HFG1 and HFG2 passing through at least one of the first to fourth pumps 104a, 104b, 104c, and 104d may be injected into any one of the first to fourth reactors 120a, 120b, 120c, and 120d through the third gas supply pipe 16a and the ninth gas supply pipe 32.

At least one of the first to fourth reactors 120a, 120b, 120c, and 120d may primarily burn the first and second harmful gases HFG1 and HFG2. In an implementation, when the first reactor 120a is not able to treat the first and second harmful gases HFG1 and HFG2 or has a small treatment capacity, the first reactor 120a may transfer the first and second harmful gases HFG1 and HFG2 to the second to fourth reactors 120b, 120c, and 120d through the eighth gas connection pipe 18h to burn the first and second harmful gases HFG1 and HFG2.

At least one of the first to fourth reactors 120a, 120b, 120c, and 120d may transfer the primarily burnt first and second harmful gases HFG1 and HFG2 to the first wet treatment performer 130a through the tenth gas connection pipe 18j as indicated by the arrows. The first wet treatment performer 130a may discharge the first and second purified gases PUG1 and PUG2 through a secondary treatment of dissolving the primarily treated gas in water, i.e., dissolve harmful components of the gas in water. When the secondary treatment is insufficient in the first wet treatment performer 130a, the second to fourth wet treatment performers 130b, 130c, and 130d may secondarily treat the gas secondarily treated in the first wet treatment performer 130a through the ninth gas connection pipe 18i.

The first and second purified gases PUG1 and PUG2 discharged from at least one of the first to fourth wet treatment performers 130a, 130b, 130c, and 130d may pass through the fourth gas discharge pipe 34, the first gas discharge pipe 20a, and the second gas discharge pipe 22a, and then discharged into the air through the first house scrubber device 200a. If necessary, an eighth gas discharge pipe may be connected to the second gas discharge pipe 22a so that the first and purified gases PUG1 and PUG2 may be discharged into the air through the second house scrubber device 200b.

The scrubber system 100-7 as described above may purify the first and second harmful gases HFG1 and HFG2 using the first to fourth pumps 104a, 104b, 104c, and 104d, the first to fourth reactors 120a, 120b, 120c, 120d, and the first to fourth wet treatment performers 130a, 130b, 130c, and 130d.

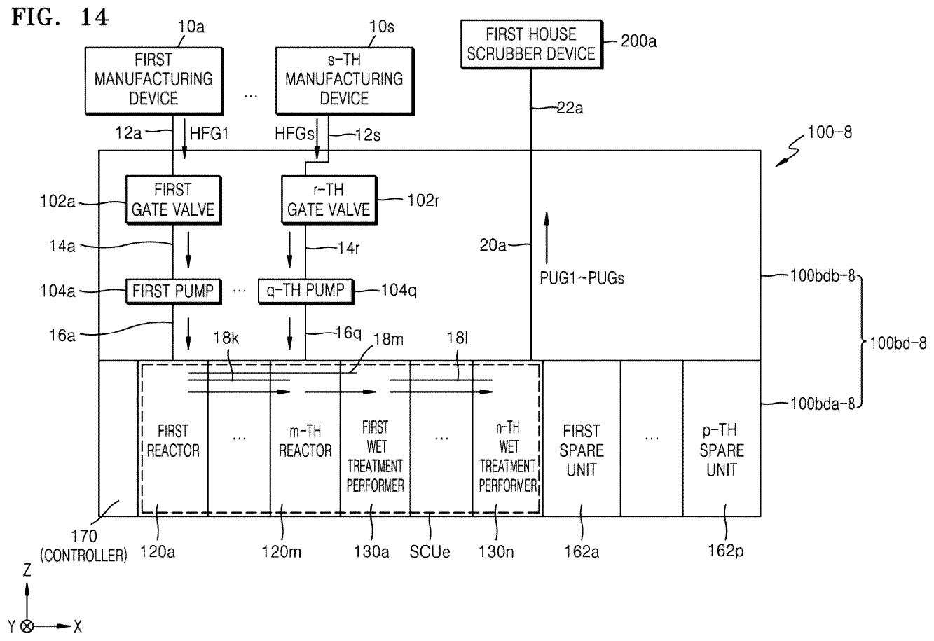

FIG. 14 is a cross-sectional, schematic view of a scrubber system 100-8 according to an example embodiment. Compared to the scrubber system 100-7 of FIG. 13, the scrubber system 100-8 may be substantially the same as the scrubber system 100-7 of FIG. 13, except that a configuration of a scrubber SCUe may be different and first to q-th pumps 104a to 104q and first to r-th gate valves 102a to 102r may be installed in the upper body 100bdb-8. The description provided above with respect to FIG. 13 will not be repeated, unless necessary, with respect to FIG. 14.

The scrubber system 100-8 may include a body 100bd-8 including a lower body 100bda-8 and an upper body 100bdb-8. In the scrubber system 100-8, the controller 170 may be located in the lower body 100bda-8.

The scrubber system 100-8 may include the scrubber SCUe located in the lower body 100bda-8. The scrubber system 100-8 may further include first to p-th spare installers 162a to 162p for installing additional scrubbers in the lower body 100bda-8. The scrubber SCUe and the first to p-th spare installers 162a to 162p may be configured in the form of a chiffonier.

The scrubber SCUe may include a plurality of reactors 120a to 120m and a plurality of wet treatment performers 130a to 130n. In an implementation, the scrubber SCUe may include first to m-th reactors 120a to 120m and first to n-th wet treatment performers 130a to 130n.

The first to m-th reactors 120a to 120m may be adjacent to each other. The first to n-th wet treatment performers 130a to 130n may be adjacent to each other.

The scrubber system 100-8 may include an eleventh gas connection pipe 18k connecting the first to m-th reactors 120a to 120m, a twelfth gas connection pipe 18l connecting the first to n-th wet treatment performers 130a to 130n, and a thirteenth gas connection pipe 18m connecting the first to m-th reactor 120 a to 120m to the first wet treatment performer 130a.

In the scrubber system 100-8, the first to q-th pumps 104a to 104q may be located in the upper body 100bdb-8. The first to q-th pumps 104a to 104q may be above the scrubber SCUe in the Z direction, so that the first harmful gas HFG1 to an s-th harmful gas HFGs (s may be a positive integer) may have a good gas flow in the Z direction, and thus, a phenomenon in which foreign matter, such as powder, occurs in the first to q-th gas supply pipes 16a to 16q may be suppressed, prevented or eliminated.

The first to s-th harmful gases HFG1 to HFGs (here, s may be a positive integer) respectively discharged from first to s-th manufacturing devices 10a to 10s may be introduced into the scrubber system 100-8 through the first to s-th gas supply pipes 12a to 12s, as indicated by the arrows. The first to r-th gate valves 102a to 102r may be connected to the first to s-th gas supply pipes 12a to 12s, respectively.

The first to s-th harmful gases HFG1 to HFGs passing through the first to r-th gate valves 102a to 102r may be injected to the first to m-th reactors 120a to 120m through the second to r-th gas supply pipes 14a to 14r, the first to q-th pumps 104a to 104q, and the third to q-th gas supply pipes 16a to 16q, respectively.

The first to q-th harmful gases HFG1 to HFGs passing through the first to q-th pumps 104a to 104q may be injected into the first to m-th reactors 120a to 120m through the third to q-th gas supply pipes 16a to 16q, respectively.

The first to s-th harmful gases HFG1 to HFGs may be primarily burned in the first to m-th reactors 120a to 120m, respectively. In an implementation, when the first harmful gas HFG1 is not processed in the first reactor 120a or a treatment capacity is small, the second to s-th harmful gases HFG2 to HFGs may be transferred from the first reactor 120a to the second to m-th reactors 120b to 120m through the eleventh gas connection pipe 18k to be burned.

At least one of the first to m-th reactors 120a to 120m may transfer the primarily burnt first to s-th harmful gases HFG1 to HFGs to the first wet treatment performer 130a through the thirteenth gas connection pipe 18m, as indicated by the arrow. The first wet treatment performer 130a may discharge first to s-th purified gases (PUG1 to PUGs, where s may be a positive integer) through a secondary treatment of dissolving the primarily treated gas in water, i.e., dissolve harmful components of the gas in water. When the secondary treatment is insufficient in the first wet treatment performer 130a, the gas secondarily treated in the first wet treatment performer 130a may be secondarily treated in the second to n-th wet treatment performers 130b to 130n through the twelfth gas connection pipe 18l.

The first to s-th purified gases PUG1 to PUGs discharged from at least one of the first to n-th wet treatment performers 130a to 130n may pass through the first gas discharge pipe 20a and the second gas discharge pipe 22a and may then be discharged into the air through the first house scrubber device 200a.

In the scrubber system 100-8 as described above, the first to s-th harmful gases HFG1 to HFGs may be purified using various components, such as the first to q-th pumps 104a to 104q, the first to m-th reactors 120a to 120m, and the first to n-th wet treatment performers 130a to 130n.

By way of summation and review, a scrubber system capable of purifying harmful gases discharged from manufacturing devices is disclosed. Because these harmful gases may be highly toxic, explosive, and corrosive, it is necessary to purify these harmful gases below an allowable concentration using a scrubber system. A scrubber system may be capable of adjusting gas purification capacity, as well as easily purifying harmful gases discharged from a manufacturing device.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A scrubber system, comprising:
a lower body;
a scrubber located in the lower body, the scrubber including a reactor and a wet treatment performer connected to the reactor, and the scrubber being configured in the form of a chiffonier;
an upper body located on the lower body; and
a pump located in the upper body for pumping a harmful gas from a manufacturing device into the reactor,
the scrubber purifying the harmful gas and discharging a purified gas outside of the upper body.

2. The scrubber system as claimed in claim 1, wherein the reactor is adjacent to the wet treatment performer, and the reactor is connected to the wet treatment performer through a gas connection pipe.

3. The scrubber system as claimed in claim 1, wherein:
the scrubber includes a plurality of reactors and a plurality of wet treatment performers, and
the plurality of reactors are respectively connected to the plurality of wet treatment performers by gas connection pipes.

4. The scrubber system as claimed in claim 1, wherein the lower body further includes at least one spare installer for installing at least one additional scrubber.

5. The scrubber system as claimed in claim 1, wherein:
a gas supply pipe supplying harmful gas from the manufacturing device through the pump is further connected to the reactor, and
a gas discharge pipe discharging purified gas is further connected to the wet treatment performer.

6. The scrubber system as claimed in claim 1, further comprising:
in the upper body, a first gas supply pipe supplying harmful gas from the manufacturing device through a gas inlet, a gate valve connected to the first gas supply pipe, a second gas supply pipe connecting the gate valve to the pump, and a third gas supply pipe connecting the pump to the reactor.

7. The scrubber system as claimed in claim 1, further comprising:
in the upper body, a first gas discharge pipe connected to the wet treatment performer to discharge purified gas purified in the scrubber, and a second gas discharge pipe discharging purified gas from the first gas discharge pipe to a house scrubber device through a gas outlet.

8. A scrubber system, comprising:
a lower body;
a first scrubber and a second scrubber adjacent to each other in the lower body, wherein the first scrubber includes a first reactor and a first wet treatment performer connected to the first reactor, the second scrubber includes a second reactor and a second wet treatment performer connected to the second reactor, and the first scrubber and the second scrubber are configured in the form of a chiffonier;
an upper body located on the lower body; and
a first pump located in the upper body, the first pump providing a first harmful gas from a first manufacturing device into the first reactor, the first scrubber purifying the first harmful gas and discharging a first purified gas to the outside of the upper body, and
the first pump providing a second harmful gas from a second manufacturing device into the second reactor, the second scrubber purifying the second harmful gas and discharging a second purified gas to the outside of the upper body.

9. The scrubber system as claimed in claim 8, wherein:
the first reactor is adjacent to the first wet treatment performer, and
the first reactor is connected to the first wet treatment performer through a first gas connection pipe.

10. The scrubber system as claimed in claim 8, wherein:
the second reactor is adjacent to the second wet treatment performer, and
the second reactor is connected to the second wet treatment performer through a second gas connection pipe.

11. The scrubber system as claimed in claim 8, wherein:
a gas supply pipe supplying the first harmful gas from the first manufacturing device through the first pump is further connected to the first reactor, and
a gas discharge pipe discharging the first purified gas is further connected to the first wet treatment performer.

12. The scrubber system as claimed in claim 8, wherein:
a gas supply pipe supplying the second harmful gas from the second manufacturing device is further connected to the second reactor, and
a gas discharge pipe discharging the second purified gas is further connected to the second wet treatment performer.

13. The scrubber system as claimed in claim 8, further comprising:
in the upper body, a first gas supply pipe supplying the first harmful gas from the first manufacturing device through a first gas inlet, a first gate valve connected to the first gas supply pipe, a second gas supply pipe connecting the first gate valve to the first pump, and a third gas supply pipe connecting the first pump to the first reactor.

14. The scrubber system as claimed in claim 8, wherein:
a second pump is further provided in the upper body, and
the second pump supplies the second harmful gas from the second manufacturing device into the second reactor.

15. The scrubber system as claimed in claim 14, further comprising:
in the upper body, a fourth gas supply pipe supplying the second harmful gas from the second manufacturing device through a second gas inlet, a second gate valve connected to the fourth gas supply pipe, a fifth gas supply pipe connecting the second gate valve to the second pump, and a sixth gas supply pipe connecting the second pump to the second reactor.

16. The scrubber system as claimed in claim 8, further comprising:
in the upper body, a first gas discharge pipe connected to the first wet treatment performer to discharge the first purified gas purified in the first scrubber, and a second gas discharge pipe discharging the first purified gas from the first gas discharge pipe to a first house scrubber device through a first gas outlet.

17. The scrubber system as claimed in claim 8, further comprising:
in the upper body, a third gas discharge pipe connected to the first wet treatment performer to discharge the first purified gas purified in the second scrubber, and a fourth gas discharge pipe discharging the second purified gas from the third gas discharge pipe to a second house scrubber device through the first gas outlet.

18. A scrubber system, comprising:
a lower body;
a first scrubber and a second scrubber adjacent to each other in the lower body, wherein the first scrubber includes a first reactor and a first wet treatment performer connected to the first reactor, the second scrubber includes a second reactor and a second wet treatment performer connected to the second reactor, and the first scrubber and the second scrubber are configured in the form of a chiffonier;
an upper body located on the lower body; and
a first pump located in the upper body, the first pump pumping a first harmful gas from a first manufacturing device into one of the first reactor and the second reactor, and the first scrubber and the second scrubber purify the first harmful gas to discharge a first purified gas to the outside of the upper body.

19. The scrubber system as claimed in claim 18, wherein
the first reactor is adjacent to the first wet treatment performer, and the first reactor is connected to the first wet treatment performer through a first gas connection pipe,
the second reactor is adjacent to the second wet treatment performer, and
the second reactor is connected to the second wet treatment performer through a second gas connection pipe.

20. The scrubber system as claimed in claim 18, wherein:
a gas supply pipe supplying the first harmful gas from the first manufacturing device through the first pump is further connected to the first reactor and the second reactor, and
a gas discharge pipe discharging the first purified gas is connected to the first wet treatment performer and the second wet treatment performer.
